(19) United States
(12) Patent Application Publication
(10) Pub. No.: US 2025/0360668 A1
(43) Pub. Date: Nov. 27, 2025

(54) ROLLER SORTER DIRECTLINK

(71) Applicant: KRONES AG, Neutraubling (DE)

(72) Inventors: Dieter WUENSCHE, Straubing (DE); Florian GELTINGER, Donaustauf (DE)

(21) Appl. No.: 18/874,899

(22) PCT Filed: Mar. 27, 2023
(86) PCT No.: PCT/EP2023/057777

§ 371 Date: Dec. 13, 2024

(30) Foreign Application Priority Data
Jun. 13, 2022 (DE) 10 2022 114 820.3

(51) Int. Cl. B29C 49/42

(52) U.S. Cl. CPC B29C 49/42057; B29C 49/4238

(57) ABSTRACT

An apparatus for feeding plastic preforms to a forming device for forming plastic preforms, includes a transport device for transporting plastic preforms having two rotatable and mutually parallel arranged rollers, between which the plastic preforms can be guided. The transport device has first portion and second portions, a first portion having sorting device for bringing the plastic preforms into a predetermined orientation, and a second portion having a hold-down device, which determines a vertical position of the plastic preforms with respect to the transport device. The two rotatable and mutually parallel arranged rollers each extend over the entire first and second portions of the transport device and/or the hold-down device is arranged above the two rotatable and mutually parallel arranged rollers.

The present invention relates to an apparatus for producing plastic containers and in particular to an apparatus for feeding plastic preforms to a blow-molding machine for producing plastic containers.

In this regard, it is known that the plastic preforms are first heated and then, when in a heated state, formed into plastic containers. Plastic preforms, for example starting from a loose bulk material (silo), are usually first sorted and then in a sorted state fed to a heating device. In the prior art, preform feed rails are used for this purpose, which represent the remaining element between, for example, a sorting device such as a roller sorter, and a blow-molding machine, for example the oven of the blow-molding machine.

Since the transport of the plastic preforms via the preform feed rails takes place due to gravity, it is necessary to arrange the apparatus for feeding the plastic preforms on a specially designed raised platform next to the machine. Such an arrangement involves considerable technical effort and financial expenditure. Furthermore, the feed apparatuses known from the prior art take up a very large surface area. In addition, maintenance work that may be required is often expensive due to the size and, above all, the elevated arrangement. In addition, the transition from a roller sorter to the preform feed rails is a location prone to failure.

For this reason, the object of the present invention is providing an apparatus for feeding plastic preforms which, in comparison with the prior art, involves less technical effort, makes a lower arrangement of the feed apparatus possible, and takes up less space.

This object is achieved according to the invention by an apparatus and a method according to the independent claims. Advantageous embodiments and developments are the subject-matter of the dependent claims.

An apparatus according to the invention for feeding plastic preforms to a forming device for forming plastic preforms into plastic containers has a transport device for transporting plastic preforms along a predetermined transport path, wherein the transport device has two rotatable and mutually parallel rollers, between which the plastic preforms can be guided. Furthermore, the transport device has a first portion and a second portion, wherein the first portion of the transport device has a sorting device for sorting plastics, which is suitable and intended for bringing the plastic preforms into a predetermined orientation. The second portion of the transport device is arranged after the first portion of the transport device, in the transport direction, wherein the second portion of the transport device has a hold-down device which extends at least in portions along the transport path in the region of the second portion and is suitable and intended for determining a height position of the plastic preforms in relation to the transport device.

According to the invention, the two rotatable and mutually parallel arranged rollers each extend over the entire first and second portions of the transport device, and/or the hold-down device is arranged above the two rotatable and mutually parallel arranged rollers.

Compared to the solutions known from the prior art, this offers the advantage that the apparatus for feeding plastic preforms can be provided as a complete (pre-assembled) module. Furthermore, the use of a feed rail, which feeds the plastic preforms to the forming station using gravity and serves as a buffer zone, can be completely dispensed with. It is conceivable here to modify an embodiment of a roller sorter known from the applicant's internal prior art, for example with a length of 6 meters.

In a preferred embodiment, the transport device has two mutually parallel rollers, between which the plastic preforms can be guided. Preferably, the rollers are rotatable about their own axes and particularly preferably rotatable in opposite directions to each other. Preferably, the rollers are adjustable and particularly preferably the distance between the rollers is adjustable (as desired). This offers the advantage that the transport device can be adapted to different types of plastic preforms, in particular to plastic preforms with different geometric dimensions. In an advantageous embodiment, a position of the two rotatable and mutually parallel arranged rollers can be adapted to a geometric size of the plastic preforms.

In a further preferred embodiment, an adjustment of a distance between the rollers can be carried out centrally and this adjustment can preferably be carried out manually or automatically. Here it is possible that only the position of one roller is adjustable in order to adjust the distance, but it would also be conceivable that the positions of both rollers are adjustable in the same way. In this way, a position of a geometric center between the two rollers can be maintained during adjustment.

In an advantageous embodiment, the transport device has at least two portions. Preferably, the two rollers extend continuously through both portions of the transport device and particularly preferably through the entire transport device. Preferably, the two rollers are each formed in one piece. Preferably, the apparatus for feeding plastic preforms is preceded by a feed belt, via which individual plastic preforms can be fed from a storage container (silo) in a loose and unordered state.

Preferably, a part of the first portion of the transport apparatus corresponds to a sorting device, in particular a roller sorter, which is suitable and intended for bringing the plastic preforms into a predetermined orientation. By rotating the two rollers in opposite directions, the sorting device makes it possible to align the plastic preforms in such a way that the opening of the plastic preforms points upwards (opposite to the direction towards the center of the earth).

In an advantageous embodiment, the apparatus is arranged at an angle of at least 3°, preferably at least 4°, preferably at least 5°, preferably at least 6°, preferably at least 7° and preferably 8° relative to a horizontal plane, and/or the apparatus is arranged at an angle of at most 20°, preferably at most 18°, preferably at most 16°, preferably at most 14°, preferably at most 12°, preferably at most 10° and preferably at most 9° relative to the horizontal plane.

In a further preferred embodiment, the transport of the plastic preforms is effected exclusively by the downhill force which occurs in the region of the rollers.

In an advantageous embodiment, the transport device has an air application device which is suitable and intended for transporting plastic preforms by an air stream.

In a preferred embodiment, an air application device is provided which is suitable and intended for removing incorrectly sorted plastic preforms from the transport path.

In a further preferred embodiment, an air application device is provided which serves to at least temporarily convey the plastic preforms, in particular during start-up operation.

Preferably, the or an air application device has a plurality of nozzles along the transport device, by which the plastic preforms can be moved by an air stream (in the transport direction). Due to the arrangement between two oppositely rotating rollers and a sloping arrangement of the transport device, the plastic preforms can be easily moved by the application of air. Preferably, the nozzles are controllable or the strength of the air output (pressure, flow rate, volume and the like) is controllable and preferably adaptable to different types of plastic preforms. Preferably, the position of the nozzles is controllable and particularly preferably adaptable to a geometric size of the plastic preforms.

Furthermore, it is conceivable that an air application device is provided above the transport path of the plastic preforms, for example in the region of a hold-down device, and/or that an air application device is arranged below the sorting rollers.

In an advantageous embodiment, the first portion of the transport device has an ejection device which is arranged downstream of the sorting device in the transport direction and is suitable and intended for removing and in particular ejecting incorrectly oriented plastic preforms from the transport path. In this case, for example a so called kicker wheel can be provided, which ejects incorrectly oriented plastic preforms from the transport path. In a preferred embodiment, a positioning of the ejection device is adjustable and in particular adjustable to different geometries of the plastic preforms. Preferably, the ejection device is arranged above the transport path (above the two rollers) such that plastic preforms which are found above a predetermined and preferably adjustable height position can be ejected by the ejection device.

In an advantageous embodiment, the second portion of the transport device has a rotary segment which is suitable and intended for arranging the plastic preforms without jamming.

In a further advantageous embodiment, the second portion of the transport device has an apparatus which is suitable and intended for discharging the sorted plastic preforms guided by the upper hold-down device.

In a preferred embodiment, the second portion of the transport device has a hold-down device which is suitable and intended for determining a height position of the (transported) plastic preforms in relation to the transport device. The plastic preforms are transported by rotating the two rollers in opposite directions while simultaneously applying compressed air in the transport direction. Since the plastic preforms sit loosely between the two rollers and these are not held in place (for example) by holding devices, the transported plastic preforms will not all be at the same height, for example in relation to a level of the rollers. For this reason, a hold-down device is provided, which serves as an upper stop and keeps the plastic preforms at a constant height. This offers the advantage that the plastic preforms can be better fed to the sawtooth starwheel of the downstream forming station.

In an advantageous embodiment, the hold-down device is adjustable in a height position and preferably adaptable to a geometric size of the plastic preforms.

In an advantageous embodiment, a separation device is arranged downstream of the transport device in the transport direction, which separation device preferably has an inlet barrier and a single-cycle starwheel, wherein the separation device being arranged directly downstream of the two rotatable and mutually parallel arranged rollers of the transport device. In this context, “directly” means that there is no further component, in particular no discharge rail, between the separation device and the two rollers of the transport device.

This offers the advantage that the plastic preforms can be transferred directly from the roller sorter to the separation device and a feed rail—as required in the prior art—can be completely dispensed with.

Preferably, the separation device has a singly-cycle starwheel which is designed as a sawtooth starwheel and is suitable and intended to separate plastic preforms which are transported adjacently to one another by the roller sorting, and for feeding them to the oven.

Preferably, the separation device has an inlet barrier which is suitable and intended for controlling a supply of mutually adjacent plastic preforms to the separation device.

In an advantageous embodiment, the plastic preforms can be transferred directly from the two rotatable and mutually parallel arranged rollers to the separation device and preferably to the inlet barrier.

The present invention is further directed to a plant for forming plastic preforms into plastic containers, having a transport device for transporting plastic preforms along a predetermined transport path, wherein the transport device has two rotatable and mutually parallel arranged rollers. Furthermore, the plant has an oven for heating the plastic preforms and a separation device for individually feeding plastic preforms to the oven, wherein the separation device has an inlet barrier and a single-cycle starwheel and is arranged in the transport direction between the transport device and the oven.

According to the invention, the plastic preforms can be transferred directly from the two rotatable and mutually parallel arranged rollers to the separation device and preferably to the inlet barrier. In this context, “directly” means that the two rotatable rollers arranged parallel to each other are directly adjacent to the inlet barrier and there is no other component, in particular no discharge rail, between them.

A plant according to the invention for forming plastic preforms into plastic containers preferably has a previously described apparatus for feeding plastic preforms according to any advantageous embodiment, whereby all features described in connection with the apparatus are also considered to be disclosed for the plant.

The present invention is further directed to a method for feeding plastic preforms to a forming device for forming plastic preforms into plastic containers, having a transport device for transporting plastic preforms along a predetermined transport path (and/or wherein a transport device transports the plastic preforms along a predetermined transport path), wherein the transport device has two rotatable and mutually parallel arranged rollers between which the plastic preforms are guided. Furthermore, the transport device has a first portion and a second portion, wherein the first portion of the transport device has a sorting device for sorting plastics, which brings the plastic preforms into a predetermined orientation, wherein the second portion of the transport device is arranged after the first portion of the transport device in the transport direction, wherein the second portion of the transport device has a hold-down device which extends at least in portions along the transport path in the region of the second portion and determines a height position of the plastic preforms in relation to the transport device.

According to the invention, the two rotatable and mutually parallel arranged rollers each extend over the entire first and second portions of the transport device, and/or the hold-down device is arranged above the two rotatable and mutually parallel arranged rollers.

In a preferred method, the plastic preforms are fed to the apparatus via a feed belt, wherein the individual plastic preforms are removed from a storage container (silo) in a loose and unordered state. Preferably, the transport device has two rollers, each of which extends over the entire transport device and is preferably formed in one piece. Preferably, the transport device has two portions, wherein the plastic preforms are transported one after the other through the first and then through the second portion. Preferably, the plastic preforms are fed to the first portion of the transport device by the feed belt. Preferably, the first portion of the transport device has a sorting device, which is preferably designed as a roller sorter. Preferably, the two rollers are arranged parallel to each other and particularly preferably are rotatable in opposite directions. By a rotational movement of the two rollers in opposite directions, the transported plastic preforms are aligned in such a way that their elongate body is arranged between the rollers and the head region of the plastic preforms is arranged above the two rollers. Preferably, the plastic preforms sit loosely between the two rollers.

In an advantageous method, a separation device is arranged downstream of the transport device in the transport direction, which separation device preferably has an inlet barrier and a single-cycle starwheel, wherein plastic preforms are transferred directly from the two rotatable and mutually parallel arranged rollers to the separation device.

Preferably, the transport device has an air application device which transports the plastic preforms by an air stream. In an advantageous method, the plastic preforms are transported by an air stream.

Preferably, a plurality of nozzles is arranged along the transport device in such a way that application of compressed air to the plastic preforms causes them to move in the transport direction. Preferably, the transport device is arranged at an angle of 8° to a horizontal, whereby transport of the plastic preforms driven by application of compressed air to the plastic preforms can be effected more easily.

Preferably an ejection device is arranged in the first portion of the transport device in the transport direction downstream of the sorting device, by which ejection device incorrectly oriented plastic preforms can be ejected from the transport path. The ejection device is designed in the form of a kicker wheel, which is arranged above the two rollers. Preferably, the kicker wheel is arranged such that plastic preforms which project beyond a predetermined and preferably adjustable height above the transport device are ejected by the kicker wheel. In an advantageous method, incorrectly oriented plastic preforms are ejected.

Preferably, the second portion of the transport device has a rotary segment which arranges the plastic preforms without jamming. Preferably, the second portion of the transport device has a hold-down device which holds the plastic preforms at a predetermined and particularly preferably adjustable height in relation to the transport device or the two rollers of the transport device. In an advantageous method, the hold-down device is adjustable in a height position and preferably adaptable to a geometric size of the plastic preforms.

In a preferred embodiment, the second portion of the transport device opens into an inlet region of the downstream forming device, wherein the inlet region is preferably designed as an inlet barrier which controls a feed of the plastic preforms. Preferably, the plastic preforms are transferred to a sawtooth starwheel in the region of the inlet barrier, which sawtooth starwheel feeds the plastic preforms to a downstream oven for heating the plastic preforms.

Furthermore, the present invention is directed to a method for operating a plant for forming plastic preforms into plastic containers, with a transport device which transports the plastic preforms along a predetermined transport path, wherein the transport device has two rotatable and mutually parallel arranged rollers. Furthermore, an oven for heating the plastic preforms and/or an oven which heats the plastic preforms and a separation device for individually feeding plastic preforms to the oven (and/or a separation device which individually feeds the plastic preforms to the oven) are provided, wherein the separation device has an inlet barrier and a single-cycle starwheel, wherein the separation device is arranged in the transport direction between the transport device and the oven.

According to the invention, the plastic preforms are transferred directly from the two rotatable and mutually parallel arranged rollers of the transport device to the inlet barrier.

A method according to the invention for operating the plant preferably includes a previously described method for feeding plastic preforms in any embodiment, whereby all features described in connection with methods for feeding plastic preforms can also be considered as disclosed for the method for operating the plant.

Further advantages and embodiments emerge from the accompanying drawings, in which:

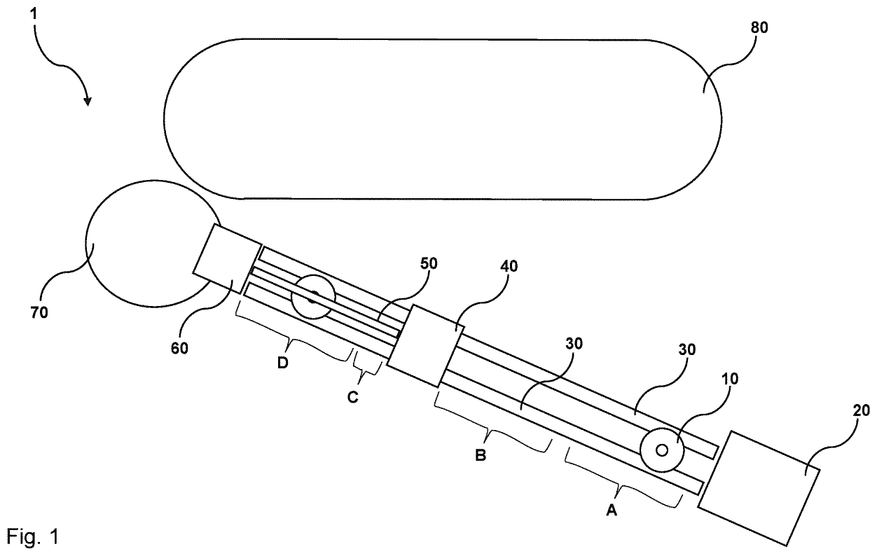

FIG. 1 shows an apparatus for feeding plastic preforms.

FIG. 1 shows an apparatus 10 for feeding plastic preforms. First of all, plastic preforms 10 are filled into a storage container (silo) (not shown) and fed to the apparatus via a suitable conveyor device (not shown) and a feed belt 20. The apparatus 1 has two rollers 30 which are arranged parallel to each other and can rotate in opposite directions.

In a first region A (sorting device) of the transport device (first portion), the plastic preforms 10, which are fed in an unordered manner via a feed belt 20, are aligned by the two opposite running rollers in such a way that the mouth of the plastic preforms 10 points upwards (essentially opposite to the direction towards the center of the earth).

Any plastic preforms 10 which cannot be aligned in this way preferably drop down to the side and can be fed back into the region A via a transport apparatus (not shown). The region A is followed by the region B, which is assigned to a downstream ejection device 40. The ejection device 40 can be designed as a kicker wheel, which ejects incorrectly oriented plastic preforms from the transport path.

The regions A and B represent the first portion of the transport device. The ejection device 40 is followed by the region C, which contains a rotary segment which eliminates possible jamming of the plastic preforms 10. This is followed by the region D, which opens into the transition region (inlet barrier 60) to the sawtooth starwheel 70, via which the plastic preforms can be fed to the forming station and, more precisely, to the oven 80 for heating the plastic preforms.

The regions C and D represent the second portion of the transport device. In the second portion of the transport device, a hold-down device is arranged which holds the plastic preforms 10 transported in the regions C and D at a constant height.

The applicant reserves the right to claim all features disclosed in the application documents as essential to the invention, provided that they are novel over the prior art individually or in combination. It is also pointed out that features which can be advantageous in themselves are also described in the individual figures. A person skilled in the art will immediately recognize that a particular feature described in a figure can be advantageous even without the adoption of further features from this figure. Furthermore, the person skilled in the art will recognize that advantages can also result from a combination of several features shown in individual or in different figures.

### LIST OF REFERENCE SIGNS

1 apparatus
10 plastic preform
20 feed belt
30 roller
40 ejection device
50 hold-down device
60 inlet barrier
70 sawtooth starwheel
80 oven
A region A
B region B
C region C
D region D

1. An apparatus for feeding plastic preforms to a forming device for forming plastic preforms into plastic containers, comprising a transport device configured for transporting plastic preforms along a predetermined transport path, wherein the transport device comprises two rotatable and mutually parallel arranged rollers, between which the plastic preforms can be guided, wherein the transport device comprises a first portion and a second portion, wherein the first portion of the transport device comprises a sorting device for sorting plastic, which sorting device is configured to bring the plastic preforms into a predetermined orientation, wherein the second portion of the transport device is arranged downstream of the first portion of the transport device in the transport direction, wherein the second portion of the transport device comprises a hold-down device, which extends at least partly along the transport path in the region of the second portion and is configured to determine a height position of the plastic preforms with respect to the transport device,
wherein
the two rotatable and mutually parallel arranged rollers each extend over the entire first and second portions of the transport device and/or the hold-down device is arranged above the two rotatable and mutually parallel arranged rollers.

2. The apparatus according to claim 1,
wherein
a separation device is arranged downstream of the transport device in the transport direction, which separation device preferably has an inlet barrier and a singly-cycle starwheel, wherein the separation device is arranged directly after the two rotatable and mutually parallel arranged rollers of the transport device.

3. The apparatus according to claim 1,
wherein
the plastic preforms can be transferred directly from the two rotatable and mutually parallel arranged rollers to the separation device and preferably to the inlet barrier.

4. The apparatus according to claim 1,
wherein
the first portion of the transport device has an ejection device which is arranged in a region of the sorting device and/or downstream of the sorting device in the transport direction and is configured for ejecting incorrectly oriented plastic preforms from the transport path.

5. The apparatus according to claim 1,
wherein
the second portion of the transport device has a rotary segment which is configured for arranging the plastic preforms without jamming, and/or the second portion has an apparatus which is configured for discharging the sorted plastic preforms guided by the upper hold-down device.

6. The apparatus according to claim 1,
wherein
the apparatus is arranged at an angle of at least 3°, preferably at least 4°, preferably at least 5°, preferably at least 6°, preferably at least 7° and preferably 8° relative to a horizontal plane, and/or the apparatus is arranged at an angle of at most 20°, preferably at most 18°, preferably at most 16°, preferably at most 14°, preferably at most 12°, preferably at most 10° and preferably at most 9° relative to the horizontal plane.

7. The apparatus according to claim 1,
wherein
a position and in particular a distance between the two rotatable and mutually parallel arranged rollers can be adapted to a geometric size of the plastic preforms.

8. The apparatus according to claim 1,
wherein
an adjustment of the distance between the rollers can be carried out centrally and this adjustment can be carried out manually or automatically.

9. The apparatus according to claim 1,
wherein
the hold-down device is adjustable in a height position and preferably adaptable to a geometric size of the plastic preforms.

10. The apparatus according to claim 9,
wherein
the adjustment of the hold-down device can be carried out centrally and/or this adjustment can be carried out manually or automatically.

11. A plant for forming plastic preforms into plastic containers with a transport device configured for transporting plastic moldings along a predetermined transport path, wherein the transport device has two rotatable and mutually parallel arranged rollers, with an oven for heating the plastic preforms and with a separation device for feeding separated plastic preforms to the oven, wherein the separation device has an inlet barrier and a singly-cycle starwheel, wherein the separation device is arranged in the transport direction between the transport device and the oven,
wherein
the plastic preforms can be transferred directly from the two rotatable and mutually parallel arranged rollers of the transport device to the separation device and preferably to the inlet barrier.

12. A method for feeding plastic preforms to a forming device for forming plastic preforms into plastic containers, wherein a transport device transports the plastic preforms along a predetermined transport path, wherein the transport device has two rotatable and mutually parallel arranged rollers, between which the plastic preforms are guided, wherein the transport device has a first portion and a second portion, wherein the first portion of the transport device has a sorting device for sorting plastics, which brings the plastic preforms into a predetermined orientation, wherein the second portion of the transport device is arranged downstream of the first portion of the transport device in the transport direction, wherein the second portion of the transport device has a hold-down device which extends at least in portions along the transport path in the region of the second portion and determines a height position of the plastic preforms in relation to the transport device,
wherein
the two rotatable and mutually parallel arranged rollers each extend over the entire first and second portions of the transport device, and/or the hold-down device is arranged above the two rotatable and mutually parallel arranged rollers.

13. The method according to claim 10,
wherein
a separation device is arranged after the transport device in the transport direction, which separation device preferably has an inlet barrier and a single-cycle starwheel, wherein plastic preforms are transferred directly from the two rotatable and mutually parallel arranged rollers to the separation device.

14. The method according to claim 12,
wherein
incorrectly oriented plastic preforms are ejected.

15. The method for operating a plant for forming plastic preforms into plastic containers with a transport device which transports the plastic moldings along a predetermined transport path, wherein the transport device has two rotatable and mutually parallel arranged rollers, with an oven for heating the plastic preforms and/or an oven which heats the plastic preforms and with a separation device for individually feeding plastic preforms to the oven, wherein the separation device has an inlet barrier and a single-cycle starwheel, wherein the separation device is arranged in the transport direction between the transport device and the oven,
wherein
the plastic preforms are transferred directly from the two rotatable and mutually parallel arranged rollers of the transport device to the inlet barrier.

16. The apparatus according to claim 2,
wherein
the plastic preforms can be transferred directly from the two rotatable and mutually parallel arranged rollers to the separation device and preferably to the inlet barrier.

17. The apparatus according to claim 2,
wherein
the first portion of the transport device has an ejection device which is arranged in a region of the sorting device and/or downstream of the sorting device in the transport direction and is configured for ejecting incorrectly oriented plastic preforms from the transport path.

18. The apparatus according to claim 2,
wherein
the second portion of the transport device has a rotary segment which is configured for arranging the plastic preforms without jamming, and/or the second portion has an apparatus which is configured for discharging the sorted plastic preforms guided by the upper hold-down device.

19. The apparatus according to claim 2,
wherein
a position and in particular a distance between the two rotatable and mutually parallel arranged rollers can be adapted to a geometric size of the plastic preforms.

20. The apparatus according to claim 2,
wherein
an adjustment of the distance between the rollers can be carried out centrally and this adjustment can be carried out manually or automatically.
